(19) United States
(12) Patent Application Publication
(10) Pub. No.: US 2006/0086550 A1
(43) Pub. Date: Apr. 27, 2006

(54) Microburst cold air forced induction system

(76) Inventors: Chad D. Hagan, Nicholasville, KY (US); Robert N. Chaffee, Georgetown, KY (US)

Correspondence Address: LAW OFFICE OF STEVEN B. LEAVITT, 9914 WATERVIEW PARKWAY, ROWLETT, TX, 75089, US

(21) Appl. No.: 10/974,646

(22) Filed: Oct. 27, 2004

(51) Int. Cl. B60K 13/02

(52) U.S. Cl. 180/68.3

(57) ABSTRACT

An air intake system including a filter, a first pipe, a fan, and a second pipe. The filter is located behind the grill or inside the fender well outside the engine bay so the filter does to not draw any hot under-hood air. The filter is attached to the first pipe which has spiraling groves cut into the inside of the pipe to transform the turbulent air drawn in through filter into a smooth spiraling stream which provides a more consistent mixture of oxygen. The first pipe is attached to the fan wherein the fan increases the velocity of the air. The fan is attached to the second pipe which has spiraling groves in the same direction as the spiraling grooves in the first pipe. The second pipe is attached to the engine's air box by an airtight connection and delivers the smooth spiraling stream of air at a relatively high velocity to the engine.

### BACKGROUND OF THE INVENTION

1. Technical Field

The present invention relates to an air intake system for an internal combustion engine and more particularly to an air intake system that creates a uniform flow of air through the use of spiraled grooves within a pipe and also increases the rate of airflow to the engine by using a powered fan located inside the pipe.

2. Background of the Invention

One of the keys to engine performance with a combustion engine vehicle is the air intake system. A typical internal combustion engine, for use in an automobile, for example, requires approximately 14.7 parts of air for each part of gasoline in the combustion chamber. Therefore, getting enough quality air to the engine from the intake system is essential. To improve the quality of air in the intake system, numerous modifications can be done.

A common modification is to add a cold air induction system to improve the efficiency of the air intake system. Most stock engine intake systems consist of an intake air box with a filter located somewhere within the engine bay. As such, the air intake box draws in hot air from under the vehicle's hood. The hot air is less dense than the ambient air and contains a relatively lower concentration of oxygen.

The ideal gas equation, PV=nRT, shows the relationship between the pressure, temperature, and volume of a gas. Essentially if the air is colder, it is denser. Denser air provides more oxygen allowing a combustion engine to burn more fuel and generate more power. A common rule of thumb holds that decreasing the air intake temperature by 10° F. will increase horsepower and torque by about 1%. The converse is also true in that a 10° F. rise in intake temperature will decrease horsepower by about 1%.

An example of a common cold air intake comprises a cone filter on a tube such as a plastic drain pipe, metal drier hose, ABS plastic fittings, or fiberglass or carbon fiber. A problem with such a system is that the flow of air is often turbulent and can contain pockets of reduced air pressure containing relatively small amounts of air or pockets of increased air pressure containing relatively large amounts of air. This is a problem because there may be periods when the engine is receiving more oxygen than it needs followed by periods when the engine's oxygen level is deficient. Thus, efficient combustion cannot always be achieved using a common cold air intake.

Therefore, what is needed is a system that can substantially provide a uniform (laminar) or, at least, a less turbulent flow of relatively cold air Thus, an even mixture of oxygen can be supplied to the engine for combustion. Even more beneficial, the system should be relatively inexpensive and easy to install. The system should preferably not detract from the appearance of the vehicle on which it is used.

Also, the system should increase the velocity of the air being delivered to the engine because an increase in air velocity increases the engine's volumetric efficiency; which maximizes the amount of air that each cylinder can ingest during each intake stroke. Consequently, if the velocity of the air is relatively high, then more air is able to enter the combustion chamber during the limited time period of the intake stroke. The more air that is able to enter the combustion chamber, the more oxygen that is present for combustion.

### SUMMARY OF THE INVENTION

The present invention provides a system for providing a uniform flow of air with an even mixture of oxygen to a combustion engine.

The system includes a filter, a first pipe, a fan, and a second pipe. A suitable filter location is behind the grill or inside the fender well which is outside the engine bay so the filter avoids drawing hot under-hood air. The filter is attached to the first pipe which has spiraling groves cut into the inside of the pipe to transform the turbulent air that has been drawn in through filter into a smooth spiraling stream of air. The spiraling stream of air is more uniform than the turbulent air and provides a more consistent mixture of oxygen.

The first pipe is attached to the fan such that the connection is airtight. The fan rotates in the same direction as the spiraling groves so the rotation of the fan does not disrupt the smooth spiraling stream of air. The spinning of the fan blades increase the velocity of the air. The fan is electrically driven and may be connected to a toggle switch whereby the user controls when the fan is activated or the fan may be connected to the engine's ignition system such that the fan is activated when the engine is started. The fan is attached to the second pipe such that the connection is airtight.

The second pipe also has spiraling groves cut into the inside of the pipe and the spiraling grooves are in the same direction as the spiraling grooves in the first pipe. The second pipe is attached to the engine's air box by an airtight connection and delivers the smooth spiraling stream of air at a relatively high velocity to the carburetor or, on fuel injected cars, to the throttle body.

Because the system requires few parts it is relatively inexpensive and easy to install. The system is virtually hidden from an observer and therefore does not detract from the appearance of the vehicle it is used on.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a plan view of a first embodiment of the present invention;

FIG. 2 is a plan view of a second embodiment of the present invention;

FIG. 3 is a cross sectional view of the first pipe extending from a filter end to a fan side of the first pipe of the present invention;

FIG. 4 is a cross sectional view of the second pipe extending from a fan side to an air box side of the second pipe of the present invention; and

FIG. 5 is a plan view of a fan of the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness. Throughout this specification and the claims which follow, unless explicitly described to the contrary, the word “comprise” or variations such as “comprises” or “comprising” will be understood to imply the inclusion of stated elements but not the exclusion of any other elements.

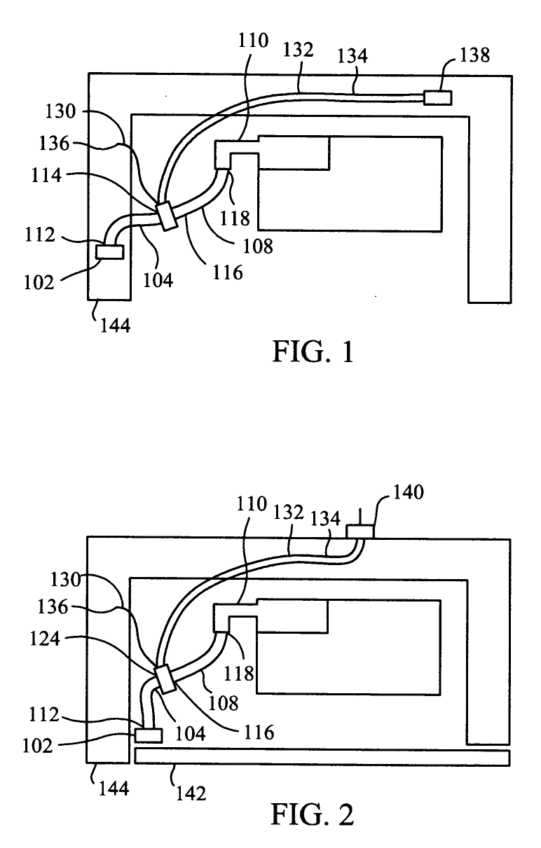

As shown in FIG. 1, the air intake system comprises filter 102, first pipe 104, fan 106, second pipe 108, and engine air box 110. Filter 102 is attached to filter end 112 of first pipe 104. Fan side 114 of first pipe 104 is attached to fan 106 by an airtight connection such that relatively little to no air escapes at the connection. Fan 106 is attached to fan side 116 of second pipe 108 by an airtight connection such that relatively little to no air can escape at the connection. Air box side 118 of second pipe 108 is attached to engine air box 110 by an airtight connection such that relatively little to no air escapes at the connection.

Filter 102 can be any commercially available filter for use on cold air induction systems but is preferably a low-restriction cloth air filter. An example of a low-restriction cloth air filter is a K&N cotton filter available from K&N Engineering, Inc. located at 1455 Citrus Ave. Riverside, Calif. 92502. Filter 102 is located outside the engine bay to avoid having the filter draw any hot air surrounding the engine. Filter 102 is preferably located behind the grill 142 as shown in FIG. 2 or inside the fender well 144 as shown in FIG. 1. Positioning of filter 102 is such that it can draw in a sufficient amount of air to facilitate combustion. Filter 102 is attached to filter end 112 of first pipe 104.

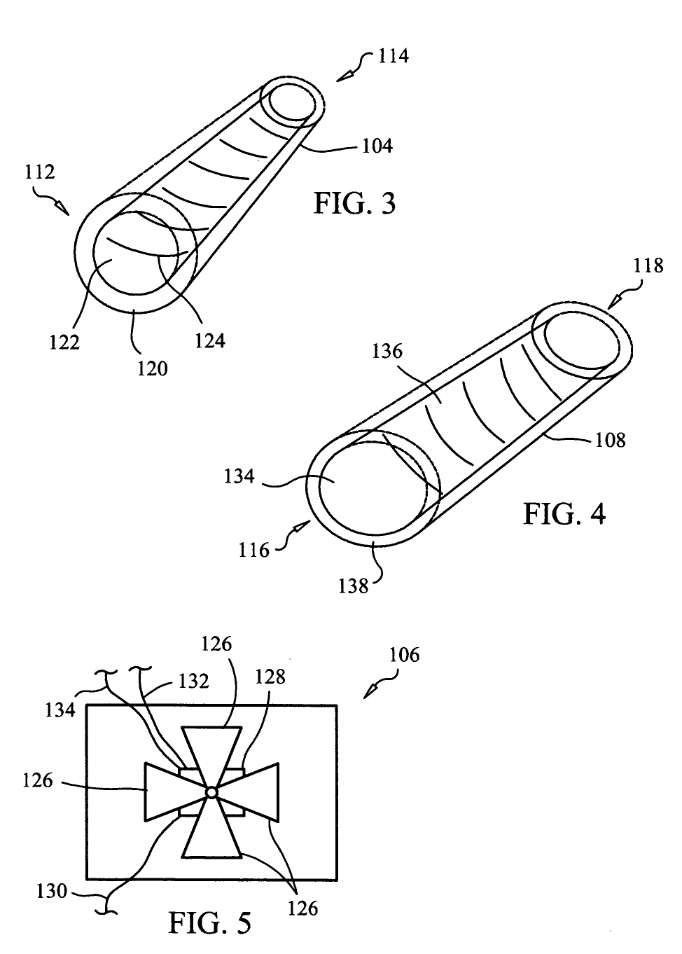

In the embodiments shown in FIGS. 1 and 2, first pipe 104 is about 1 to about 5 inches in diameter and is preferably about 3 inches in diameter. As shown in FIG. 3, wall 120 of first pipe 104 is about 1/16 inch to about 1 inch thick and is preferably about ¼ inch thick. First pipe 104 is preferably made of aluminum but may be comprised of any hard metal, plastic drain pipe, metal drier hose, ABS plastic fittings, fiberglass, carbon fiber, or other suitable material. Although PVC pipe may be used, it is not preferred as typically PVC does not possess the temperature resistance of other more suitable metals and plastics. On the inside wall 122 of first pipe 104 are grooves 124.

Grooves 124 are between about 1/16 inch to about 1 inch thick and are preferably about ⅛ inch thick. Grooves 124 spiral around inside wall 122 towards engine air box 110. The purpose of grooves 124 is to prevent and/or reduce any turbulent air that has been drawn in through filter 102 into a smooth spiraling stream of air. The spiraling stream of air is more uniform in consistency than the flow of turbulent air. Heretofore, the spiraling air provides a more consistent mixture of oxygen. Grooves 124 are ideally provided over the entire length of first pipe 104 from filter end 112 of first pipe 104 to fan side 114 of first pipe 104. Fan side 114 of first pipe 104 is attached to fan 106 via a sealant or some other similar attachment means known in the art for creating a relatively airtight connection so that little to no air escapes at the connection.

Fan 106 can be any commercially available fan that can fit inside first pipe 104. As shown in FIG. 5, fan 106 contains blades 126 which are made of aluminum or some other strong lightweight material able to withstand relatively high temperatures such as around 800° F. In the present embodiments shown, blades 126 are propelled by electric motor 128 and rotate in the same direction as grooves 124 so as not to disrupt the spiraling stream of air inside first tube 104. The rotation of blades 126 increases the velocity of the air flow in first pipe 104 and second pipe 108.

Electric motor 128 contains ground wire 130, positive wire 132 and negative wire 134. Ground wire 130 is attached to the vehicles frame by bolt 136 or some other similar means for fixedly attaching ground wire 130 to a grounding source. Positive wire 132 and negative wire 134 are attached to the ignition side of the vehicle's fuse box 138 so electric motor 128 is supplied with power to propel blades 126 when the vehicles ignition is turned on.

In a second embodiment, positive wire 132 and negative wire 134 are attached to toggle switch 140 mounted on the inside of the vehicle as shown in FIG. 2. Toggle switch 140 is connected to the vehicle's electrical system such that when toggle switch 140 is turned on, electric motor 128 is supplied with the power to propel blades 126. A relatively airtight seal exists where ground wire 130, positive wire 132 and negative wire 134 exit fan 106 such that the air in first pipe 104 cannot escape and continues past fan 106 to second pipe 108.

Fan 106 is attached to fan side 116 of second pipe 108 via a sealant or some other similar attachment means known in the art for creating a relatively airtight connection so that little to no air escapes at the connection. Second pipe 108 is similar to first pipe 104.

Second pipe 108 is about 1 to about 5 inches in diameter and is preferably about 3 inches in diameter. As shown in FIG. 4, wall 138 of second pipe 108 is about 1/16 inch to about 1 thick and is preferably about ¼ inch thick. Second pipe 108 is preferably made of aluminum but may be comprised of any hard metal, plastic drain pipe, metal drier hose, ABS plastic fittings, fiberglass, carbon fiber, or some other similar material. Although PVC pipe may be used, it is not preferred as typically PVC does not possess the temperature resistance of other more suitable metals and plastics. On the inside wall 134 of second pipe 108 are grooves 136. Grooves 136 are similar to grooves 124.

Grooves 136 are between about 1/16 inch to about 1 thick and are preferably about ⅛ inch thick. Grooves 136 spiral around inside wall 134 towards engine air box 110. The purpose of grooves 136 is to continue the spiraling stream of air created by grooves 124 and fan 106 and to transform the remaining turbulent air into a smooth spiraling stream of air that provides a more consistent mixture of oxygen. Grooves 136 continue the entire length of second pipe 108 from fan side 116 to air box side 118 of second pipe 108. Air box side 118 of second pipe 108 is attached to engine air box 110 by an airtight connection and delivers the smooth spiraling stream of air at a relatively high velocity to the carburetor or, on fuel injected cars, to the throttle body.

Because the groves of the present invention provide a uniform flow of relatively cold air with an even mixture of oxygen at a relatively high velocity, the engine is more efficient. For example, first pipe 104 and second pipe 108 can be adjusted or bent to accommodate any combustion engine vehicle. In addition, the present invention can be used on other combustion engine machines such as a Jet Ski, boat, chainsaw, weed eater, lawnmower, snowmobile, motorcycle, or ATV. Such modifications for use on other combustion engine machines are known in the art.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

What is claimed is:

1. An intake system for an internal combustion engine comprising:
a first pipe;
a fan connected to the first pipe; and
a second pipe connected to the fan wherein the second pipe is connected to the air box of the internal combustion engine.

2. The air intake system of claim 1 further comprising a filter attached to the first pipe on the opposite end of the fan.

3. The air intake system of claim 2 wherein the filter is located in the fender well of a vehicle

4. The air intake system of claim 2 wherein the filter is located behind the grill of a vehicle

5. The air intake system of claim 1 wherein the fan is activated when the ignition to the combustion engine is activated.

6. The air intake system of claim 1 wherein the fan is activated by a toggle switch.

7. The air intake system of claim 1 wherein the first pipe and the second pipe have internal grooves that spiral in the same direction that the fan spins.

8. The air intake system of claim 1 wherein the diameter of the first and second pipe is about 1 to about 5 inches.

9. The air intake system of claim 1 wherein the walls of first and second pipe are about 1/16 inch to about 1 inch thick.

10. The air intake system of claim 7 wherein internal grooves are about 1/16 inch to about 1 thick

11. An intake system for an internal combustion engine comprising:
a first pipe having internally spiraled grooves wherein the first pipe is connected to the air box of the internal combustion engine.

12. The air intake system of claim 1 further comprising a filter attached to the first pipe on the opposite end of the air box.

13. The air intake system of claim 12 wherein the filter is located in the fender well of a vehicle.

14. The air intake system of claim 12 wherein the filter is located behind the grill of a vehicle.

15. The air intake system for an internal combustion engine comprising:
a first pipe having internally spiraled grooves;
a fan connected to the first pipe such that the blades of the fan rotate in the same direction as the internally spiraled grooves of the first pipe; and
a second pipe having internally spiraled grooves connected to the fan wherein the second pipe is connected to the air box of the internal combustion engine and the internally spiraled grooves are in the same direction as the internally spiraled grooves of the first pipe.

16. The air intake system of claim 15 further comprising a filter attached to the first pipe on the opposite end of the fan.

17. The air intake system of claim 16 wherein the filter is located in the fender well of a vehicle.

18. The air intake system of claim 16 wherein the filter is located behind the grill of a vehicle.

19. The air intake system of claim 1 wherein the fan is activated when the ignition to the combustion engine is activated.

20. The air intake system of claim 1 wherein the fan is activated by a toggle switch.
